(19) United States
(12) Patent Application Publication
(10) Pub. No.: US 2016/0200146 A1
(43) Pub. Date: Jul. 14, 2016

(54) CAP PLY FOR PNEUMATIC TIRE AND METHOD OF MANUFACTURING CAP PLY FOR PNEUMATIC TIRE

(71) Applicant: Kumho Tire Co., Inc., Gwangju (KR)

(72) Inventor: Gab Bae Lee, Gwangju (KR)

(73) Assignee: Kumho Tire Co., Inc., Gwangju (KR)

(21) Appl. No.: 14/991,400

(22) Filed: Jan. 8, 2016

(30) Foreign Application Priority Data
Jan. 9, 2015 (KR) 10-2015-0003544

(51) Int. Cl. B60C 9/18; B29D 30/06

(52) U.S. Cl. CPC B60C 9/18; B29D 30/0681; B60C 2009/1878

(57) ABSTRACT

The present disclosure is directed to a cap ply for a pneumatic tire. The cap ply includes a film layer, a coating layer configured to surround an outer surface of the film layer and a rubber topping layer configured to surround an outer surface of the coating layer.

### CROSS-REFERENCE TO RELATED APPLICATIONS

This application claims priority to Korean Patent Application No. 10-2015-0003544, filed on Jan. 9, 2015, the disclosure of which is incorporated herein in its entirety by reference.

### TECHNICAL FIELD

The present disclosure relates to a cap ply for a pneumatic tire and a method of manufacturing a cap ply for a pneumatic tire.

### BACKGROUND

In general, a tire may have a support function of supporting an overall weight of a motor vehicle, a power delivery function of delivering drive power and brake power of a motor vehicle to a road surface, a shock relieving function of relieving an external shock generated due to an irregular road surface, and a position changing function of changing a position depending on a moving direction of a motor vehicle.

A radial tire used in a motor vehicle has a structure in which several layers are laminated one above another. The typical radial tire may have a structure in which a tread, a belt, a body ply and an inner liner are laminated in the named order from the outermost side. A cap ply that minimizes the movement of the belt and enhances the driving stability may be provided between the tread and the belt.

FIG. 1 illustrates a structure of a cap ply 1 for a pneumatic tire. As the cap ply 1 constitutes an existing pneumatic tire, there has been used a woven fabric which includes warp cords 2 formed by twisting nylon fibers as a synthetic fibers and weft cords 3 orthogonal to the warp cords 2. However, the thickness of the structure having the warp cords 2 intersecting the weft cords 3 ranges from 0.8 mm to 1.6 mm. Thus, when installing an additional rubber topping 4, the thickness of the cap ply 1 may further increase.

### PRIOR ART DOCUMENTS

Patent Document 1: Korean Patent Application Publication No. 2003-0019978

### SUMMARY

Embodiments of the present disclosure may provide a pneumatic tire that includes a cap ply having an enhanced durability and a reduced weight.

According to the embodiments of the present disclosure, it is possible to provide a pneumatic tire that includes a cap ply having an enhanced durability and a reduced weight.

### BRIEF DESCRIPTION OF THE DRAWINGS

FIG. 1 illustrates a structure of a conventional cap ply for a pneumatic tire.

FIG. 2 is a partially-cutaway perspective view illustrating a pneumatic tire including a cap ply according to one embodiment of the present disclosure.

FIG. 3 is a sectional view of the pneumatic tire illustrated in FIG. 2.

FIG. 4 illustrates a cap ply for a pneumatic tire according to one embodiment of the present disclosure.

FIG. 5 is a sectional view taken along line A-A in FIG. 4.

FIG. 6 is a flowchart of a method of manufacturing a cap ply for a pneumatic tire according to one embodiment of the present disclosure.

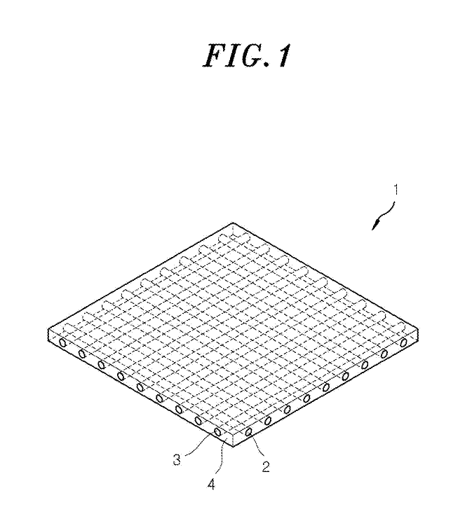

### DETAILED DESCRIPTION

Embodiments for realizing the present disclosure will now be described in detail with reference to the accompanying drawings. Detailed descriptions of well-known configurations or functions will be omitted if it is determined that the detailed descriptions may unnecessarily make obscure the spirit of the present disclosure.

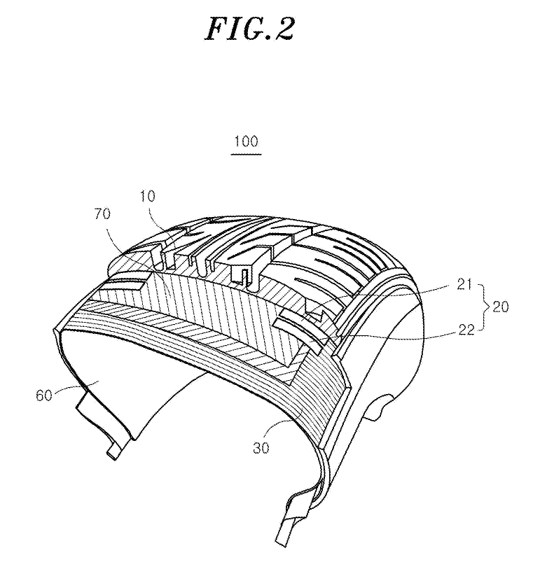

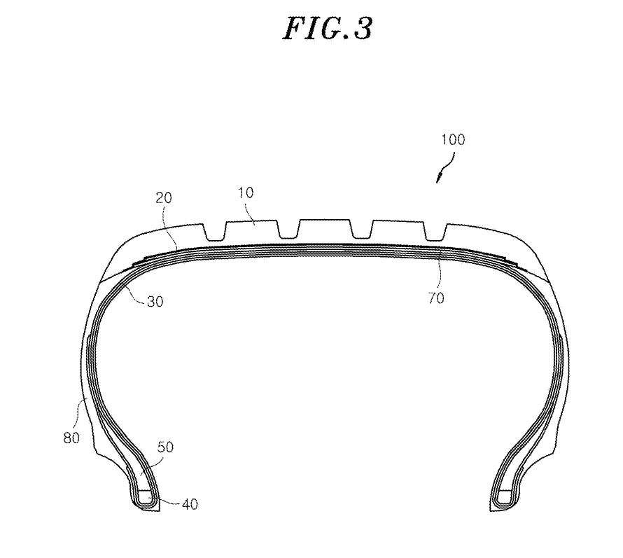

FIG. 2 is a partially-cutaway perspective view illustrating a pneumatic tire 100 including a cap ply 20 according to one embodiment of the present disclosure. FIG. 3 is a sectional view of the pneumatic tire 100 illustrated in FIG. 2.

Referring to FIGS. 2 and 3, the pneumatic tire 100 according to one embodiment of the present disclosure may include a tread 10, a body ply 30, beads 40, apexes 50, an inner liner 60, sidewalls 80, a belt 70, and a cap ply 20.

The tread 10 is a portion which makes contact with a road surface, and is capable of delivering brake power and drive power of a motor vehicle to the road surface. The body ply 30 is a cord layer existing within the pneumatic tire and is capable of supporting a weight of a motor vehicle and absorbing a shock generated by a road surface. As shown in FIG. 3, the beads 40 are rectangular or hexagonal wire bundles formed by coating rubber on steel wires and are capable of seating and fixing the pneumatic tire 100 on a rim. The apexes 50 have a function of minimizing dispersion of the beads 40 and protecting the beads 40 from an external shock.

The inner liner 60, as shown in FIG. 2, is used in place of a tube and is positioned at the innermost side of the pneumatic tire 100. The inner liner 60 can prevent leakage of an air. The belt 70 is positioned between the tread 10 and the body ply 30. The belt 70 can relieve an external shock and can widen the ground contact surface of the tread 10, thereby enhancing the driving stability of a motor vehicle.

The pneumatic tire 100 according to the present embodiment may be, for example, a high speed tire having a flatness ratio of 55 or less, a load index of 90 or more and a speed index of H-speed or more, and a battery vehicle tire having a flatness ratio of 65 or more and a width of less than 175. However, the structure of the pneumatic tire 100 according to the present embodiment is not limited to the aforementioned one but may include many different configurations. Some of the aforementioned configurations may be omitted.

The cap ply 20 according to the present embodiment can prevent a phenomenon of interlayer separation of the belt 70. Furthermore, the cap ply 20 according to the present embodiment is used to minimize the movement of the belt 70 during a driving process and to enhance the driving stability. In this embodiment, the cap ply 20 may be provided between the tread 10 and the belt 70.

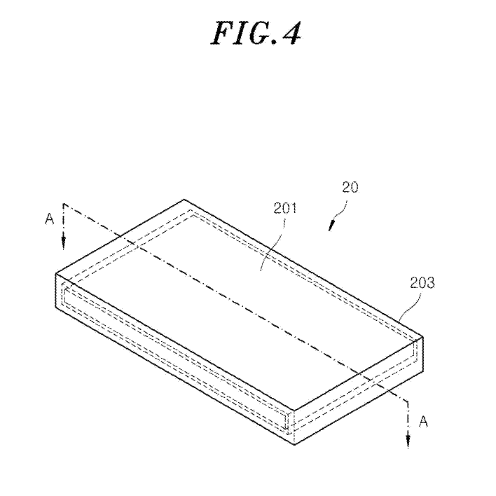

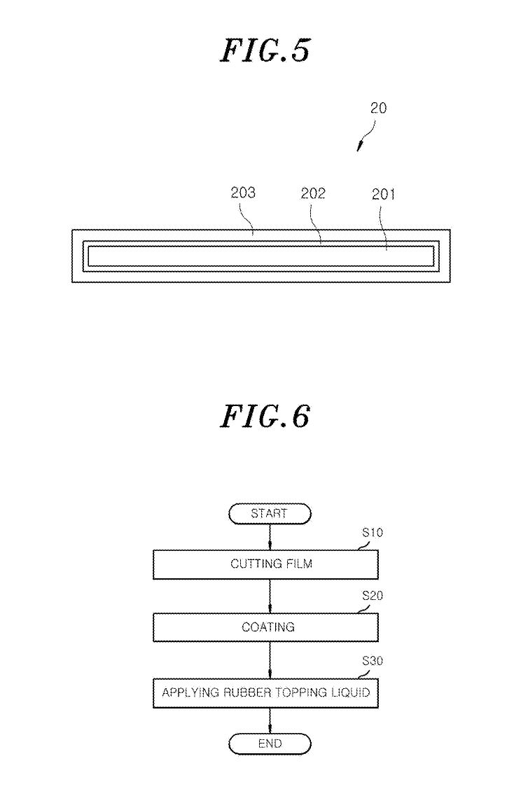

FIG. 4 illustrates the cap ply 20 for a pneumatic tire 100 according to one embodiment of the present disclosure. FIG. 5 is a sectional view taken along line A-A in FIG. 4.

Referring to FIGS. 4 and 5, a plurality of cap plies 20 may be attached to the upper side of the belt 70 (as shown in FIG. 3). As illustrated in FIG. 2, one cap ply 21 may be disposed in a spaced-apart relationship with another adjoining cap ply 22. If the cap plies 21 and 22 are disposed without any gap, an overlapping section may result between the adjoining cap plies 21 and 22. Thus, a bonding force of a boundary surface may be reduced.

However, if the cap plies 21 and 22 are disposed in a spaced-apart relationship with each other as in the present embodiment, attachment between the cap plies 21 and 22 may be prevented in a mutually overlapping relationship. Accordingly, it is possible to prevent reduction of a bonding force of a boundary surface. In this embodiment, the gap between the cap plies 20 may be about 3 mm. If the gap between the cap plies 20 exceeds 3 mm, the reinforcing effect of the cap plies 20 may be reduced. Each of the cap plies 20 may include a film layer 201, a coating layer 202 and a rubber topping layer 203.

The film layer 201 serves as a framework which enhances the durability of the cap ply 20. The film layer 201 may be a film produced by a melt spinning method. The film layer 201 may be produced by a polymer material capable of being melted. Examples of the polymer material may include polyethylene terephthalate, polyethylene naphthalate, nylon-6, nylon-66, and so forth. The thickness of the film layer 201 may be 0.2 mm to 1.0 mm.

The surface roughness of the film layer 201 may be 10 nm to 100 nm. Furthermore, the bonding force between the film layer 201 and another adjoining rubber may be 10.0 kgf/cm². Moreover, the thermal shrinkage coefficient of the film layer 201 may be 4.0% or less when the film layer 201 is left alone at 160 degrees C. for 15 minutes. In addition, the density of the film layer 201 may be 1 to 2.3 kgf/cm³ or more.

The flexing fatigue property of the film layer 201 may be 40% or more. If the flexing fatigue property of the film layer 201 is less than 40%, the probability of generation of a film crack phenomenon caused by a continuous fatigue during the use of the pneumatic tire 100 may be increased.

The coating layer 202 is a portion which covers the surface of the film layer 201 and may be configured to surround the entire outer surface of the film layer 201. The coating layer 202 may be a rubber-based bonding liquid having a bonding property. The coating layer 202 may cause the film layer 201 to be cross-linked with an adjoining rubber by sulfur. The coating layer 202 may be made of, for example, resorcinol formaldehyde latex. The latex used at this time may include 1.8 to 6.0 wt % of vinyl pyridine latex.

The rubber topping layer 203 is a layer coated on the coating layer 202 and may surround the outer surface of the coating layer 202. The rubber topping layer 203 may be an NR-based natural rubber in which the weight ratio of carbon black is 10 to 15 PHR. The rubber topping layer 203 can prevent the coating layer 202 from being destroyed by the light such as ultraviolet rays or the like and other materials. Furthermore, the rubber topping layer 203 can reinforce the film layer 201, thereby improving the structural stability of the cap ply 20. To this end, the rubber topping layer 203 may be formed on the surface of the coating layer 202 immediately after formation of the coating layer 202.

Table 1 shows the results of tests performed by attaching a plurality of cap plies 20 having the aforementioned structure to the belt 70 at intervals of 3 mm and then applying the same to a pneumatic tire 100 for an electric vehicle having a size of 155/70 R19.

TABLE 1

| | Comparative | Comparative | Example | Example | Example | Example |
|---|---|---|---|---|---|---|
| | example 1 | example 2 | 1 | 2 | 3 | 4 |
| Construction | N-66 | Hybrid | PET | N-66 | N-46 | PEN |
| | 1260D/2 P | 1000D + 840D | film | film | film | film |
| Thickness (mm) | 1.0 mm | 1.0 mm | 0.5 mm | 0.5 mm | 0.5 mm | 0.5 mm |
| Bonding force with | 100% | 98% | 100% | 100% | 100% | 95% |
| adjoining rubber | | | | | | |
| Bonding force with | 95% | 95% | 95% | 95% | 95% | 95% |
| adjoining rubber | | | | | | |
| (Aged at 75° C. for 7 | | | | | | |
| days) | | | | | | |
| Weight of pneumatic | 100 | 103 | 95% | 95% | 95% | 95% |
| tire | | | or less | or less | or less | or less |
| Load durability | 100 | 103 | 106 | 104 | 104 | 105 |
| Speed durability | 100 | 102 | 105 | 103 | 104 | 104 |
| High speed/high load | 100 | 103 | 105 | 104 | 103 | 104 |
| durability | | | | | | |

Test methods are as follows.

(a) Load Durability Evaluation

After the pneumatic tire 100 is mounted to a rim, an air is injected into the pneumatic tire 100 at a pressure of 26 psi. In the case of a general tire, a test is started at an initial speed of 120 km/hr. In the case of a snow tire, a test is started at an initial speed of 110 km/hr. The test is conducted by driving the tire at 85% of the maximum load for 4 hours and then driving the tire at a 5%-increased load for 6 hours. Thereafter, the tire is driven at a constant speed at the maximum load for 24 hours and is then driven until occurrence of an accident by applying a load of 8.5% every 2 hours.

(b) Speed Durability Evaluation

After the pneumatic tire 100 is mounted to a rim, an air is injected into the pneumatic tire 100 at a pressure of 32 psi. In the case of a general tire, a test is started at an initial speed of 140 km/hr. In the case of a snow tire, a test is started at an initial speed of 130 km/hr. The tire is driven up to 80 km for 2 hours while applying 85% of the maximum load for 4 hours. Thereafter, the tire is left alone for two hours and is then driven until occurrence of an accident by increasing the speed by 10 km/hr every 30 minutes from an initial speed of 140 km/hr.

(c) High Speed/High Load Durability Evaluation

After the pneumatic tire 100 is mounted to a rim, an air is injected into the pneumatic tire 100 at a pressure of 32 psi. In the case of a general tire, a test is started at an initial speed of 140 km/hr. In the case of a snow tire, a test is started at an initial speed of 130 km/hr. The test is conducted by driving the tire at 85% of the maximum load for 4 hours and then driving the tire at a 5%-increased load for 6 hours. Thereafter, the tire is left alone for 24 hours. Then, the air pressure is reduced to 25 psi. The test is conducted at 100% of the initial load for 1.5 hours at a speed of 140 km/hr. Thereafter, the tire is driven until occurrence of an accident by applying a load of 8.5% every 2 hours.

(d) Bonding Force with Adjoining Rubber

In a method of evaluating a bonding force of the cap ply 20 with an adjoining rubber, a sheet of adjoining rubber having a thickness of 1.5 mm to 2.5 mm is prepared.

After attaching the cap ply 20 to the adjoining rubber, the tire is vulcanized at 160 degrees C. for 20 minutes under a vulcanizing pressure of 18 kgf/cm² and is left alone at least for 4 hours. Thereafter, the bonding force of the cap ply 20 with the adjoining rubber is evaluated.

As shown in Table 1, it can be noted that, despite the reduction of thickness to 0.5 mm, the cap ply 20 including the film layer 201 is higher in load durability, speed durability and high speed/high load durability than the cap plies (of comparative examples 1 and 2) having a woven cord structure. Furthermore, it can be confirmed that the overall weight of the pneumatic tire 100 is reduced.

Hereinafter, descriptions will be made on a method of manufacturing a cap ply 20 for a pneumatic tire 100 according to one embodiment of the present disclosure.

The film layer 201 of the cap ply 20 according to one embodiment of the present disclosure may be produced by melt-spinning a polymer material such as polyethylene terephthalate, polyethylene naphthalate, nylon-6, nylon-66, or the like. Then, the film layer 201 may be cut into a predetermined width by slitting rollers disposed one above the other (S10).

The film layer 201 processed in a specified form may be coated with a rubber-based bonding liquid such as resorcinol formaldehyde latex or the like (S20). Thus, the coating layer 202 may be formed on the entire outer surface of the film layer 201. The latex used at this time may include 1.8 to 6.0 wt % of vinyl pyridine latex. Since the coating step (S20) is performed after the shape processing (cutting) of the film layer 201 is completed, it is possible to coat the coating layer 202 on the entire surface of the film layer 201.

If the coating step (S20) is completed, a rubber topping liquid may be immediately applied on the surface of the coating layer 202 (S30). Thus, the rubber topping layer 203 may be formed on the entire outer surface of the coating layer 202. The rubber topping liquid applied on the coating layer 202 may be, for example, an NR-based natural rubber in which the weight ratio of carbon black is 10 to 15 PHR.

By immediately applying the rubber topping liquid (S30) after the coating step (S20), it is possible to prevent the RFL coating layer from being destroyed by an external environment or a destructive material such as ultraviolet rays or the like. Since the weight ratio of carbon black in the rubber topping liquid falls within a range of 10 to 15 PHR, the fluidity of the rubber topping liquid is large. This enables the rubber topping liquid to be easily applied on the coating layer 202.

In the cap ply 20 according to one embodiment of the present disclosure, the conventional cord having an intersecting structure is replaced by the film layer 201. It is therefore possible to reduce the thickness and weight of the cap ply 20. Since the film layer 201 has a rectangular parallelepiped shape with a uniform thickness, it is possible to easily perform the coating step (S20) and the rubber topping liquid applying step (S30). In addition, the finally-formed cap ply 20 has a uniform thickness and shape. It is therefore possible to enhance the structural stability of the belt 70 and the pneumatic tire 100.

Since the rubber topping liquid has fluidity, it is possible to uniformly and smoothly apply the rubber topping liquid on the coating layer 202. Accordingly, it is possible to reduce the manufacturing time and manufacturing cost of the cap ply 20. In as much as the cap ply 20 has a structure in which the film layer 201, the coating layer 202 with a bonding force and the rubber topping layer 203 are laminated one above another, it is possible to secure a structural strength.

The embodiments described above are descriptions of some examples of the present technical concept. The scope of the present technical concept is not limited to the aforementioned embodiments. It will be understood by a person skilled in the relevant art that the present disclosure may be differently changed, modified or substituted without departing from the spirit and scope of the present technical concept. Such changes, modifications and substitutions shall be construed to fall within the scope of the present technical concept.

What is claimed is:

1. A cap ply for a pneumatic tire, comprising:
a film layer;
a coating layer configured to surround an outer surface of the film layer; and
a rubber topping layer configured to surround an outer surface of the coating layer.

2. The cap ply of claim 1, wherein the rubber topping layer comprises a rubber topping liquid having fluidity on the outer surface of the film layer.

3. The cap ply of claim 1, wherein the film layer comprises a polymer material selected from a group consisting of polyethylene terephthalate, polyethylene naphthalate, nylon-6 and nylon-66.

4. A pneumatic tire, comprising the cap ply of claim 1, wherein the cap ply is arranged between a tread and a belt of the pneumatic tire, and the cap ply comprises a plurality of cap plies disposed in a spaced-apart relationship with each other.

5. A method of manufacturing a cap ply for a pneumatic tire, comprising:
forming a film layer by cutting a film;
forming a coating layer by coating a coating liquid on the film layer; and
forming a rubber topping layer by applying a rubber topping liquid on the coating layer.

6. The method of claim 5, wherein forming the film layer further comprises melt-spinning a polymer material selected from a group consisting of polyethylene terephthalate, polyethylene naphthalate, nylon-6 and nylon-66.

7. The method of claim 5, wherein forming the coating layer further comprises coating the coating layer on an entire outer surface of the film layer.

8. The method of claim 5, wherein forming the rubber topping layer further comprises forming the rubber topping layer subsequently after forming the coating layer.

9. The method of claim 5, wherein the coating liquid coated on the film layer comprises resorcinol formaldehyde latex which includes 1.8 to 6.0 wt % of vinyl pyridine latex.

10. The method of claim 5, wherein the rubber topping liquid comprises an NR-based natural rubber in which a weight ratio of carbon black is 10 to 15 PHR.
